(19) United States
(12) Patent Application Publication
(10) Pub. No.: US 2008/0008904 A1
(43) Pub. Date: Jan. 10, 2008

(54) HIGHLY HEAT-TRANSFERRING SUBSTRATE

(75) Inventors: Yu Li HUANG, Taoyuan Hsien (TW); Min-Chung LU, Taoyuan Hsien (TW)

Correspondence Address: RABIN & Berdo, PC, 1101 14TH STREET, NW, SUITE 500, WASHINGTON, DC, 20005, US

(73) Assignee: Insight Electronic Group Inc., Taoyuan Hsien (TW)

(21) Appl. No.: 11/838,554

(22) Filed: Aug. 14, 2007

Related U.S. Application Data
(62) Division of application No. 11/019,259, filed on Dec. 23, 2004.

(51) Int. Cl. B32B 7/00

(52) U.S. Cl. 428/686

(57) ABSTRACT

A highly heat-transferring substrate is manufactured by drilling holes on a metal material of high heat conductivity, such as aluminum; positioning the metal material between two copper foil layers; applying a highly heat-transferring gum between the metal material and the copper foil layers; and melting the gum using a high temperature produced during pressing the metal material and the copper foil layers together. The melted gum bonds the metal material to the copper foil layers and flows into the holes on the metal material to form an insulating coating, which allows the finished substrate to be drilled and plated without the risk of short circuit caused by contacted metal material and plated coating.

### FIELD OF THE INVENTION

The present invention relates to a highly heat-transferring substrate and a process of manufacturing the substrate, and more particularly to a substrate that includes a metal material of high heat conductivity, such as aluminum, bonded between two copper foil layers using a highly heat-transferring gum, so that heat energy is rapidly transferred from the copper foil layers to the metal material via the gum and evenly dissipated. Multiple layers of metal material and copper foil may be alternately stacked or combined to enable even better heat dissipation efficiency.

### BACKGROUND OF THE INVENTION

Circuit boards have been widely employed in various fields. In general electronic products, electronic elements are inserted on the circuit boards and produce a large amount of heat during operation thereof. In response to the electronic elements that have high working power and produce high amount of heat, most of the currently available circuit boards are enhanced to increase their heat dissipation efficiency.

Since the quantity of and the power consumed by the electronic elements on the conventional circuit boards are low, a large part of heat produced by the electronic elements during operation thereof could be transferred to copper foil layers on the circuit boards and dissipated into ambient air. However, the quantity of and the power consumed by the electronic elements on the current circuit boards are extremely high. As a result, power consumption increases with high power supply to cause the problem of excessively high temperature at some local areas on the circuit boards. The conventional way of removing heat via heat transferring legs provided on the electronic elements fails to carry away most part of the produced heat, and the electronic elements and the circuit boards could not be maintained at a normal working temperature, resulting in changes in physical properties of the electronic elements and inferior working efficiency thereof. In a worse condition, the electronic elements might be burnt out or have a shortened usable life.

FIG. 1 schematically shows the structure of a conventional heat dissipating circuit board, which mainly includes a copper foil layer A1 and an aluminum sheet A2, and has a thin sheet of gum A3 laid between the copper foil layer A1 and the aluminum sheet A2. In a pressing process, the thin sheet of gum A3 is bonded to the copper foil layer A1 and the aluminum sheet A2 to form a substrate. Thereafter, electronic elements are provided on the copper foil layer A1 to produce the heat dissipating circuit board. Heat produced by the electronic elements during operation thereof is transferred from the copper foil layer A1 to the aluminum sheet A2, which provides a large heat dissipating area and accordingly, an increased heat dissipation efficiency.

Following disadvantages are found in the manufacture and use of the above-structured conventional heat dissipating circuit board:
1. Heat transfer occurs only at areas of the copper foil layer A1 that are in contact with the aluminum sheet A2. Not all the heat energy on the copper foil layer A2 could be transferred to the aluminum sheet A2. In the case of a multi-substrate circuit board, the heat transfer effect thereof is further degraded while the circuit board has unnecessarily increased volume and weight. The conventional circuit board has apparently limited heat dissipation efficiency.
2. Since the aluminum sheet A2 is attached to the copper foil layer A1, only one side of the aluminum sheet A2 that is in contact with the copper foil layer A1 provides acceptable heat transfer effect. Since the other side of the aluminum sheet A2 facing away from the copper foil layer A1 does not effectively transfer heat, the conventional heat-dissipating circuit board has lower heat transfer performance and higher manufacturing cost.
3. The usable space on the conventional heat-dissipating circuit board is largely restricted by the volume of the substrate of the circuit board. In practical use of the conventional heat-dissipating circuit board, the volume of the aluminum sheet must be taken into account along with the substrate. The bigger the substrate is, the bigger the aluminum sheet A2 will be.
4. Since the conventional heat-dissipating circuit board is not suitable for plating, only one side of which could be used.
5. The finished product of the conventional heat-dissipating circuit board is not suitable for drilling because holes on the circuit board would allow the copper plating to contact with the aluminum sheet A2 to result in short circuit when the drilled circuit board is plated.

It is therefore tried by the inventor to develop a process for manufacturing a highly heat-transferring substrate as a solution to the common issue of obtaining a circuit board with improved heat dissipating ability.

### SUMMARY OF THE INVENTION

A primary object of the present invention is to provide a highly heat-transferring substrate and a process of manufacturing the same, in which a metal material with high heat conductivity, such as aluminum, is disposed between two copper foil layers to provide an increased heat dissipating area.

Another object of the present invention is to provide a highly heat-transferring substrate and a process of manufacturing the same, in which a high heat-transferring gum is applied between a metal material and copper foil layers to serve as an insulating and bonding medium and enable quick transfer of heat from the copper foil layers to the metal material via the gum.

A further object of the present invention is provide a highly heat-transferring substrate and a process of manufacturing the same, in which a metal material is pre-drilled to form holes with predetermined diameters, and a high temperature produced during pressing the metal material and two copper foil layers together is used to melt a highly heat-transferring gum applied between the metal material and the copper foil layers for the gum to fill the holes on the metal material, so that the substrate so formed may be drilled at the holes filled with the gum and plated without the risk of causing any contact of the metal material with the plated coating to result in any short circuit.

To achieve the above and other objects, the highly heat-transferring substrate of the present invention is manufactured by drilling holes on a metal material of high heat conductivity, such as aluminum; positioning the metal material between two copper foil layers; filling a space between the metal material and each copper foil layer with a highly heat-transferring gum to serve as an insulating and bonding medium; and melting the gum using a high temperature produced during pressing the metal material and the copper foil layers together, so that the melted gum bonds the metal material to the copper foil layers and flows into and fully fills the holes on the metal material to form an insulating layer. The substrate may be drilled and plated at the holes filled with the highly heat-transferring gum, and the gum prevents the metal material from contacting with the plated coating and avoids undesired short circuit. The highly heat-transferring gum also quickly transfers heat produced by electronic elements mounted on the substrate to the metal material that provides increased heat dissipating areas, so that the substrate provides an even better heat dissipating effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the structure of a conventional heat dissipating circuit board;

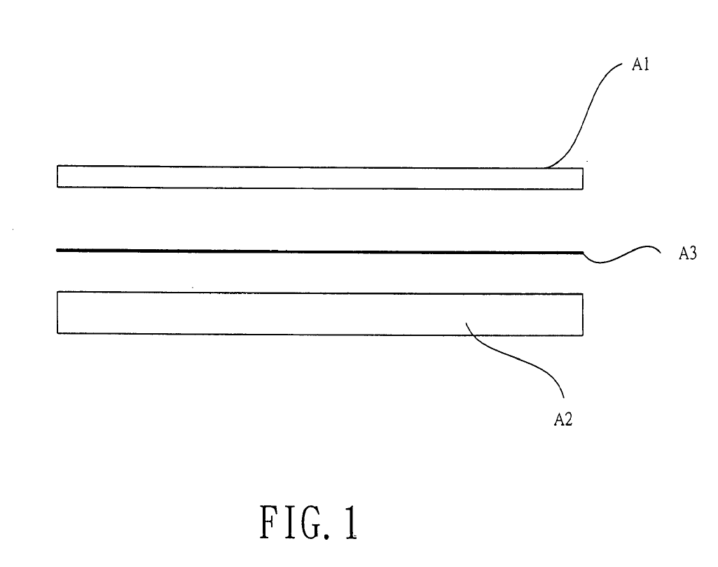

FIG. 2 shows the process of manufacturing the highly heat-transferring substrate of the present invention;

FIG. 3 shows a first embodiment of the manufacturing process of the present invention;

FIG. 4 shows a second embodiment of the manufacturing process of the present invention;

FIG. 5 schematically shows the structure of the highly heat-transferring substrate of the present invention;

FIG. 6 shows heat transfer paths in the substrate of the present invention; and

FIG. 7 shows a multi-layer circuit board manufactured according to the process of the present invention.

### DETAILED DESCRIPTION OF THE PREFERRED EMBODIMENTS

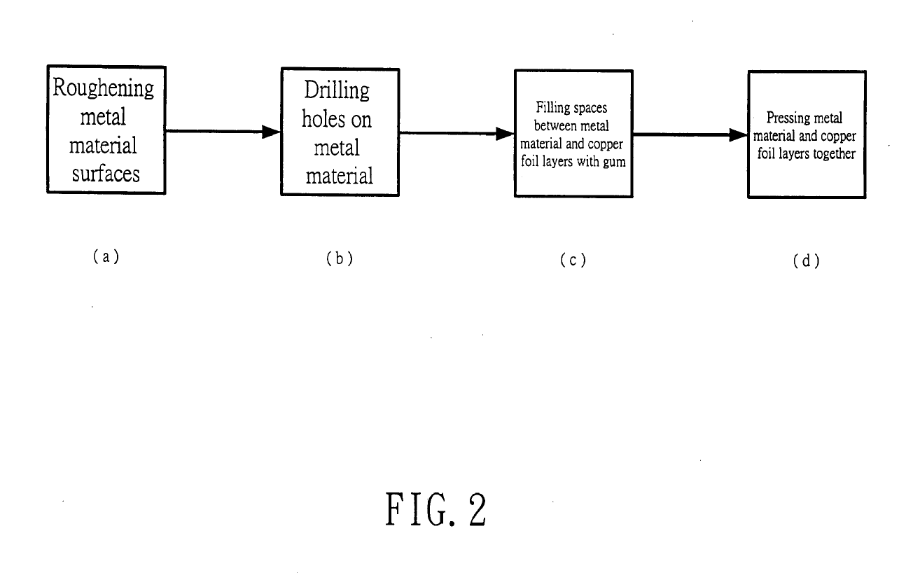

Please refer to FIG. 2 that shows the process of manufacturing a highly heat-transferring substrate according to the present invention. As shown, the manufacturing process includes the following steps:
(a) Prepare a desired metal material and give it roughened surfaces;
(b) Drill holes of predetermined diameters on the roughened metal material using a drilling machine;
(c) Fill a space between each surface of the metal material and a copper foil layer with a type of highly heat-transferring gum; and
(d) Press the metal material and the copper foil layer together.

The roughened surfaces of the metal material formed in the roughening step (a) ensure tight contact of the highly heat-transferring gum with the metal material in the pressing step (d). The degree to which each of the metal material surfaces is roughened is determined by a thickness of the metal material. And, the roughened surfaces could be obtained either by machining or sandblasting.

In the following description and corresponding drawings, the metal material, the holes drilled on the metal material, the highly heat-transferring gum, and the copper foil layers are sequentially denoted by reference numerals 1, 11, 2, and 3.

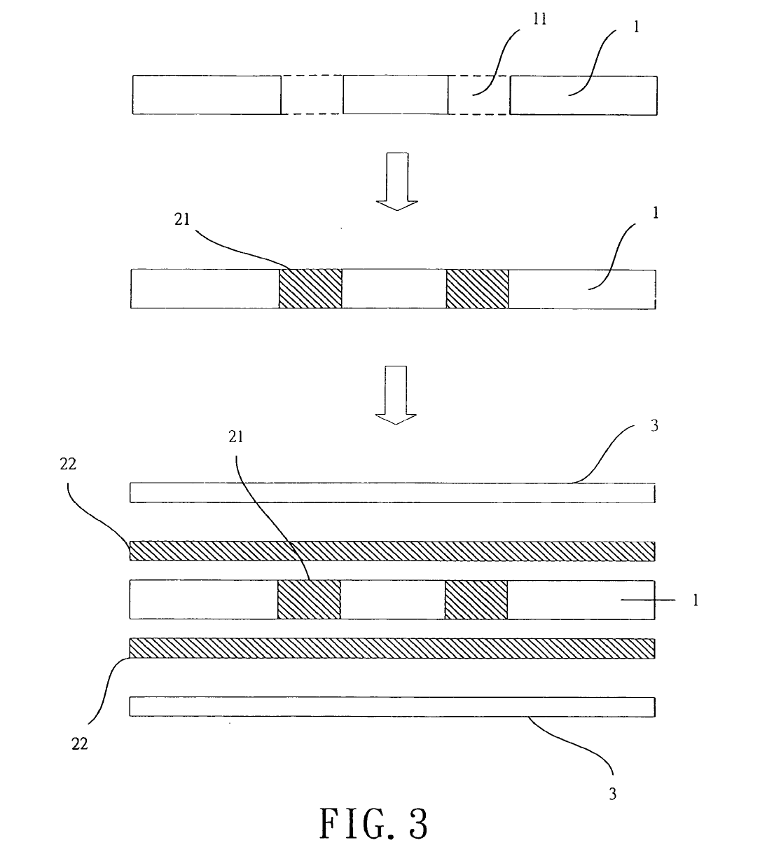

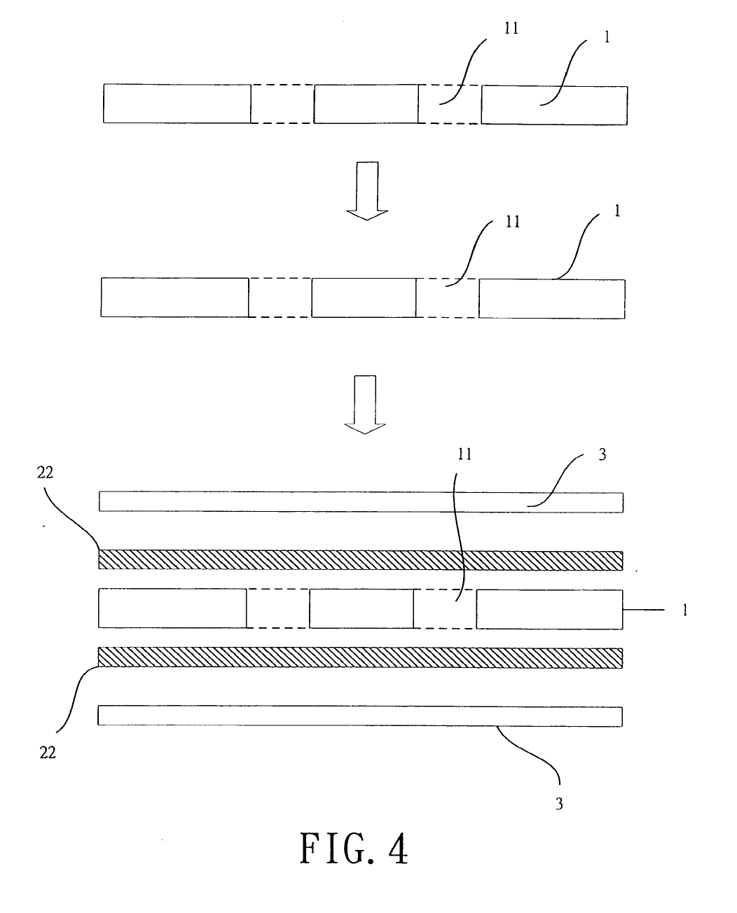

In the drilling step (b), the prepared metal material 1 is drilled to form holes 11 of predetermined diameters using a drilling machine (not shown). The diameters of the holes 11 are slightly larger than that of holes formed on the copper foil layer 3, so that the highly heat-transferring gum 2 may be filled into the holes 11. There are two types of highly heat-transferring gum 2, namely, liquid and solid heat-transferring gum 21, 22. And, the spaces between the metal material 1 and the copper foil layers 3 may be filled with the highly heat-transferring gum 2 in the filling step (c) in any one of two manners, namely, printing or melt filling, as shown in FIGS. 3 and 4, respectively.

To fill the spaces between the metal material 1 and the copper foil layers 3 with the highly heat-transferring gum 2 by printing as shown in FIG. 3, the liquid type of high heat-transferring gum 21 is used and caused to flow into and fully fill the holes 11 on the metal material 1.

To fill the spaces between the metal material 1 and the copper foil layers 3 with the highly heat-transferring gum 2 by melt filling as shown in FIG. 4, the solid type of high heat-transferring gum 22 is used and laid between the metal material 1 and the copper foil layers 3. The solid heat-transferring gum 22 is then melted due to a high temperature produced during the pressing step (d). The solid heat-transferring gum 22 on the melt flows into and fully fills the holes 11 on the metal material 1.

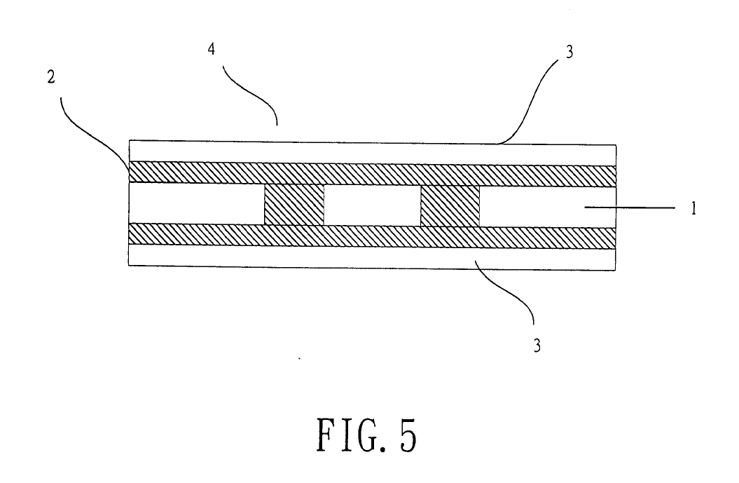

FIG. 5 shows a highly heat-transferring substrate 4 that is formed after the metal material 1, the copper foil layers 3, and the highly heat-transferring gum 2 are firmly pressed together in the pressing step (d).

The highly heat-transferring substrate 4 formed in the manufacturing process of the present invention includes a metal material 1, a layer of highly heat-transferring gum 2 laid over each surface of the metal material 1 to serve as an insulating and bonding medium; and at least one copper foil layer 3 formed over each layer of the highly heat-transferring gum 2.

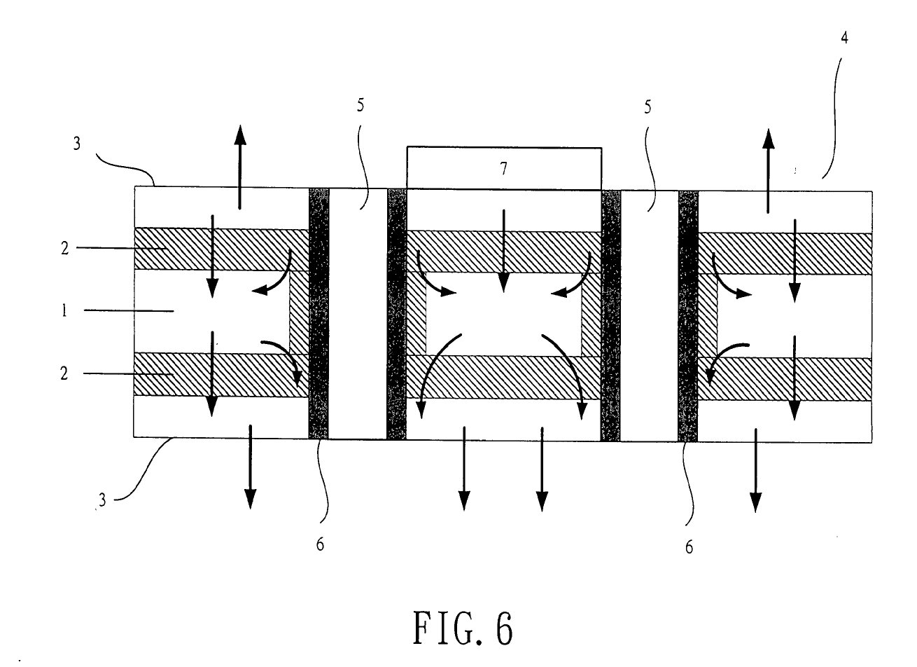

When the highly heat-transferring substrate 4 is used to manufacture a circuit board, it is first drilled to provide a plurality of through holes 5 thereon, as shown in FIG. 6. A plated coating 6 is formed over an inner wall surface of each through hole 5, which is used to receive electronic elements or to provide a path for transmitting signals between two copper foil layers 3. Since the highly heat-transferring gum 2 forms an insulating coating, the plated coating 6 is not in contact with the metal material 1 to cause any dangerous short circuit.

In the event of having electronic elements 7 directly provided on the copper foil layers 3 and heat energy being produced by the electronic elements 7, the produced heat energy is transferred to and absorbed by the metal material 1 via the highly heat-transferring gum 2, which is an excellent medium for heat transfer. The heat energy absorbed by the metal material 1 is evenly diffused or indirectly transferred to the copper foil layer 3 that forms a lower surface of the highly heat-transferring substrate 4. Through continuous heat exchange at the copper foil layers 3, the heat energy produced by the electronic elements 7 is rapidly carried away from the circuit board to achieve the purpose of quick dissipation of heat.

To achieve an even better heat dissipating effect, a metal material 1 with higher thermal conductivity, such as iron, aluminum alloy, etc., may be used to obtain an increased heat transfer efficiency.

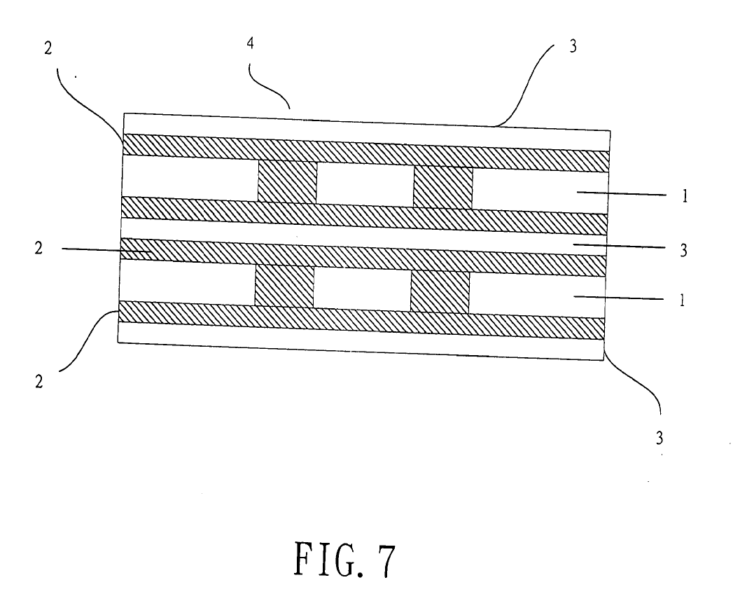

As can be seen from FIG. 7, multiple layers of alternately arranged metal material 1 and copper foil layers 3 may be included in the highly heat-transferring substrate 4 formed in the manufacturing process of the present invention, and the highly heat-transferring gum 2 is applied between any two adjacent layers of metal material 1 and copper foil layer 2 to serve as the insulating and bonding medium. The multi-layer highly heat-transferring substrate 4 has increased heat-dissipating areas as well as enhanced heat dissipation efficiency to enable quick removal of heat.

The present invention has been described with some preferred embodiments thereof and it is understood that many changes and modifications in the described embodiments can be carried out without departing from the scope and the spirit of the invention that is intended to be limited only by the appended claims.

1. (canceled)

2. (canceled)

3. (canceled)

4. (canceled)

5. (canceled)

6. (canceled)

7. (canceled)

8. A highly heat-transferring substrate, comprising:
a metal material;
a layer of highly heat-transferring gum laid over each surface of the metal material to serve as an insulating and bonding medium; and
at least one copper foil layer formed over each layer of the highly heat-transferring gum.

9. The highly heat-transferring substrate as claimed in claim 8, wherein the metal material is pre-drilled to form a plurality of holes with predetermined diameters.

10. The highly heat-transferring substrate as claimed in claim 8, wherein the metal material is aluminum.

11. The highly heat-transferring substrate as claimed in claim 8, wherein the metal material is copper.

12. The highly heat-transferring substrate as claimed in claim 8, wherein the metal material is iron.

13. The highly heat-transferring substrate as claimed in claim 8, wherein the metal material is an aluminum alloy.

14. The highly heat-transferring substrate as claimed in claim 8, wherein the highly heat-transferring gum is of a solid state.

15. The highly heat-transferring substrate as claimed in claim 8, wherein the highly heat-transferring gum is of a liquid state.
